(19) United States
(12) Patent Application Publication
(10) Pub. No.: US 2016/0260319 A1
(43) Pub. Date: Sep. 8, 2016

(54) METHOD AND SYSTEM FOR A CONTROL DEVICE TO CONNECT TO AND CONTROL A DISPLAY DEVICE

(71) Applicant: Aquimo, LLC, Mesa, AZ (US)

(72) Inventors: Mark John Jeffery, Mesa, AZ (US); Manoj Kumar Rana, Gurgaon (IN); Robert Sunshin Komorous-King, Berkeley, CA (US)

(73) Assignee: AQUIMO, LLC, Mesa, AZ (US)

(21) Appl. No.: 14/639,031

(22) Filed: Mar. 4, 2015

(51) Int. Cl. G08C 17/02

(52) U.S. Cl. CPC G08C 17/02; G08C 2201/20; G08C 2201/42

(57) ABSTRACT

Systems and methods are provided to connect a control device such as a mobile phone to a display device. The control device can be used to operate (control) an application executing at a server and/or at the display device. In an embodiment, the display device initiates a connection request to the server via a network. The server then generates a unique code, and transmits the code to the display device. The code can be displayed as a matrix barcode. The control device scans the matrix barcode and decodes it. The control device then initiates a connection request to the server and transmits the code to the server. A matching engine connects the control device to the display device corresponding to the code. The connections are preferably made via a full-duplex Internet connection protocol, such as the WebSocket protocol, to facilitate low latency network connections.

### BACKGROUND OF THE INVENTION

1. Field of the Invention

The present invention relates to a method of using a control device to connect to and control a display device.

2. Description of the Related Art

The earliest wireless remote control is attributed to Nikola Tesla, “Method of an Apparatus for Controlling Mechanism of Moving Vehicle or Vehicles,” U.S. Pat. No. 613,809, 1898. Remote controls for display devices, such as a television, have reached considerable sophistication. Typical remote controls utilize infrared and line of sight with the display; see, for example, Houghton, “TV Remote Control System,” U.S. Pat. No. 3,631,398. More recently, remote controls involve use of a computer network; see, for example, Madonna et al., “Remote Control Unit for a Programmable Multimedia Controller,” U.S. Pat. No. 8,766,782. Limitations of Madonna et al. include the need for customized, high-cost hardware, and for the system to operate using the same local area network (LAN).

### SUMMARY OF THE INVENTION

Systems and methods are provided to connect a control device such as a mobile phone to a display device. The control device can be used to operate (control) an application executing at a server and/or at the display device. In an embodiment, the display device initiates a connection request to the server via a network. The server then generates a code and transmits the code to the display device. The code can be displayed as a matrix barcode. The control device scans the matrix barcode and decodes it. The control device then initiates a connection request to the server and transmits the code to the server. A matching engine connects the control device to the display device corresponding to the code. The connections are preferably made via a full-duplex Internet connection protocol, such as the WebSocket protocol, to facilitate low latency network connections.

A notable aspect of the invention is that the server can generate the code, preferably not the display device, and the server enables both connection and control of the display device(s) by the control device(s). A related aspect and advantage of the inventive system and method is that the control device and the display device are not required to be on the same local area network (LAN), but can respectively be on any Internet connected network. As an illustrative example, in an embodiment the display device can be hard-wire connected via CAT-5 Ethernet to a wide area network (WAN) which is in turn connected to the Internet, and the control device can be connected to a different wireless cellular network which is connected to the Internet, where it is understood the example is non-limiting.

The inventive system and method enables four (4) types of distributed display device connection and control: (1) single control device controlling a single display device, (2) multiple control devices connecting to and controlling a single display device, (3) a single control device connecting to and controlling multiple display devices and (4) multiple control devices connecting to and controlling one or more multiple display devices. Each of the four embodiments has significant practical applications. Furthermore, the system and method are scalable to 100 million or more users.

An aspect of the invention is illustrated by the example preferred embodiment of a multiplayer sports game, wherein users scan Quick Response (QR) codes and connect to and control display devices in order to play virtual sports such as, but not limited to, basketball, American football, bowling or soccer. An alternate preferred embodiment is for thousands of fans in a stadium, and millions of users watching via TV, to scan the code on a TV screen or printed medium, in order to connect to and simultaneously play on the very large display device (e.g., a Jumbotron™) in the stadium. Another aspect of the invention is illustrated by an embodiment in a retail store, wherein users can connect to and control display devices in order to query product information and/or purchase the product via control of an ecommerce application.

Another aspect of the invention is that the control device can be any Internet-connected device with a processor and a camera sensor. Illustrative non-limiting examples of control devices are a smart phone, a smart watch, and wearable computing eyewear.

The techniques described herein are extensible to control a plurality of games and content applications. These and other aspects, features, and advantages of the present invention will become apparent from the following detailed description of preferred embodiments, which is to be read in connection with the accompanying drawings.

### BRIEF DESCRIPTION OF THE FIGURES

FIG. 1 (a) illustrates a control device;

FIG. 1 (b) illustrates an externally connected device useable with the control device;

FIG. 2 illustrates a system to connect to and control a display device via a control device, according to an embodiment;

FIGS. 3 (a)-(b) illustrate a method to connect to and control a display device via a control device, according to an embodiment;

FIG. 4 illustrates a method wherein multiple control devices are connected to multiple display devices, according to an embodiment;

FIG. 5 illustrates three different groups of players connected and playing sports games using the method and system described herein customized for sports games, according to an embodiment;

FIG. 6 illustrates numerous players connected to a singular web-enabled display in a stadium arena, in order to simultaneously play a sports game, according to an embodiment;

FIG. 7 illustrates multiple control devices simultaneously controlling the same multimedia presentation on respective display devices in different continents, according to an embodiment;

FIG. 8 illustrates a retail store embodiment, wherein multiple shoppers connect to display devices to query additional product and sales information using the method and system described herein, according to an embodiment; and

FIG. 9 illustrates a grocery store with display devices in shopping carts wherein the shoppers connect to the display devices, according to an embodiment.

### DETAILED DESCRIPTION OF THE INVENTION

For clarity and consistency, the following definitions are provided for use herein:

As used herein, a control device refers to a device having a processor, memory and sensors including, but not limited to, a camera. In certain embodiments, the sensors are integral to the control device. However, in other embodiments, the sensors can include external sensors. In certain embodiments the control device may have integrated memory and a processor, and in other embodiments the processing may be enabled in a console, PC or other mobile device, connected via a cable or wirelessly to the control device.

As used herein, a display device is any device with the capability to connect to the Internet and display content.

As used herein display software is any software that enables display of content on a display device.

As used herein, a code comprises an arrangement of one or more characters, numerals or symbols. In various embodiments, the code can be displayed as plain text, a Universal Product Code (UPC) code, or a two-dimensional barcode matrix such as the Quick Response (QR) code.

As used herein a code display device is any device with the capability to connect to the Internet and to display a code, preferably in a matrix barcode format.

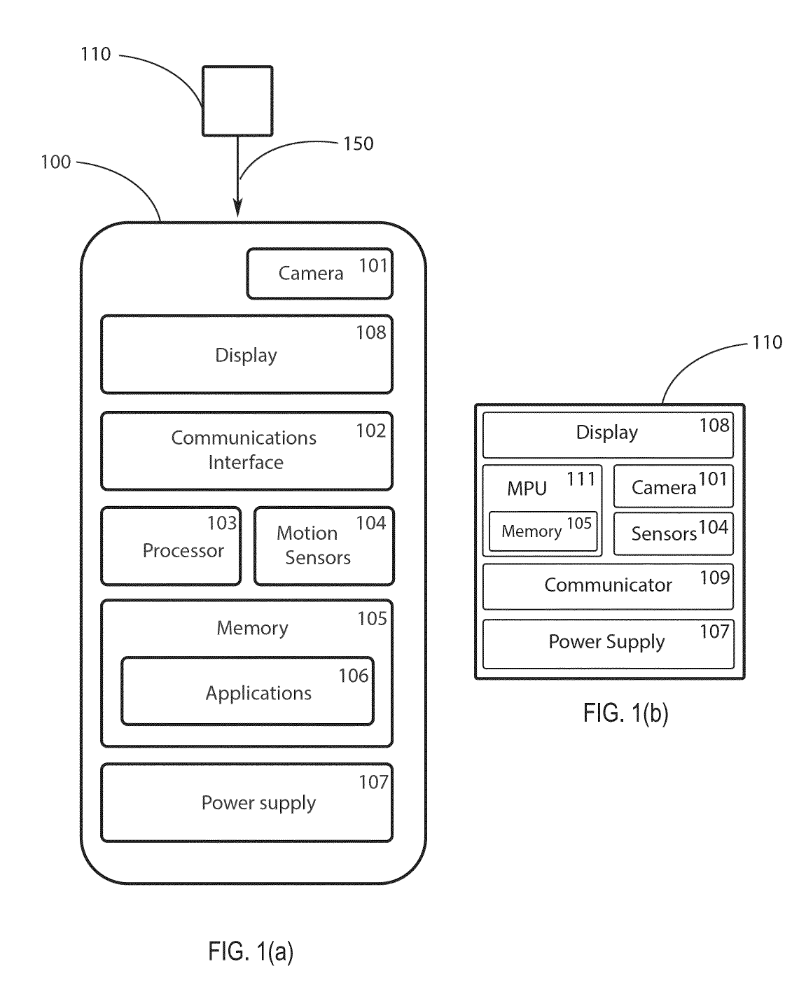

FIG. 1 (a) illustrates an exemplary control device 100, such as an Apple iPhone 6 which includes a camera 101, a communication interface 102, a processor 103, motion sensors 104, memory 105, and a power supply 107. The communication interface 102 controls various input/output devices including a digital camera 101, a 30-pin dock connector port, a headphone jack, a built-in speaker and microphone, and a QUALCOMM WTR1625L RF cellular transceiver. The communication interface 102 also connects to a touchscreen display 108. The processor 103 is a dual core Apple AS processor which has a system-on-a-chip (SOC) architecture that integrates the main processor, graphics silicon, and other functions such as a memory controller. The motion sensors 104 can include a three-axis gyroscope to measure a rate of rotation around a particular axis and an accelerometer to measure acceleration in three dimensions X, Y and Z. The memory 105 includes 16 GB or 64 GB of flash memory (depending on the model). The memory 105 includes storage for a software application 106 (“app”), which in part includes the software of the invention. The power supply 107 includes a rechargeable lithium-polymer battery and power charger.

FIG. 1 (a) is also illustrative of the Samsung Galaxy S5 and Galaxy Note 4 exemplary control devices, where Samsung's incorporation similarly includes a camera 101, a communication interface 102, mobile processor (MPU) 103, motion sensors 104, memory 105, and a power supply 107. The communication interface works the same on the Galaxy S5 and Galaxy Note 4 whereas multiple input/output devices are also enabled including a 16 Megapixel HDR digital camera, a USB hybrid 3.0/2.0 connecting port, headphone jack, heart rate sensor, and a built-in speaker with dual noise cancellation microphones. The communication interface 102 also includes a touch-screen display 108 with enhanced features and sensitivity not requiring the screen to physically be touched to operate. The processor 103 is a QUALCOMM Snapdragon quad-core 2.5 GHz (Galaxy Note 4 is clocked higher due to screen size) CPU with Adreno 330 GPU, a programmable system-on-a-chip (PSOC) architecture with integration for other functions such as the memory controller. The memory 105 includes 16 GB and 32 GB of flash with an internal SD card slot expansion, which can expand memory with an additional 64 GB. The memory 105 includes storage for an application 106 (“app”), which in part includes the software of the invention. The power supply 107 includes a lithium-polymer battery and power charger that can be removed and/or expanded.

FIG. 1 (a) is also illustrative of a code display device, although this device need not have the sensors 104 and/or the camera 101, or cellular transceiver. An exemplary code display device example is the low-cost Nobis 7 which has a communication interface 102, mobile processor (MPU) 211, high definition display 108, memory 105, Wi-Fi IEEE 802.11b chip set 102, and a dedicated power supply 107. The Nobis 7 communication interface works such that the tablet must be connected via Wi-Fi (IEEE 802.11b) to a computer network. The processor 103 is a Quad Core processor 1.2 GHz system on a chip (SOC) architecture with integration for other functions such as the memory controller with 2 GB of RAM and 8 GB of dedicated flash memory. The memory 105 includes storage for an application 106 (“app”) which includes the software of the invention with respect to display of the code. The power supply 107 includes a lithium-polymer battery, claimed to last 5 hours a day, and is not removable.

Illustrative examples of display devices include, but are not limited to, a web enabled liquid crystal display (LCD) television (TV), tablet computers such as an Apple iPad or Amazon Kindle Fire or Android Galaxy Note, a laptop computer with a screen, and any display connected to a personal computer. It is understood that the display device will have an architecture consisting of a display 108, processor 103, memory 105, communication interface 102, and power supply 108. The minimum software requirement for the display device processor 104 and memory 105 is that the device should support an HTML5 compliant web page, or other display software that supports standard protocols, and hence have the capability to connect to the internet and process Java Script and AJAX and support web-sockets. Exemplary browsers are Google Chrome, Internet Explorer, Mozilla Firefox, or Apple Safari. In an alternate embodiment the display device may run an App 106 with the similar input-output communication characteristics as an HTML5 compliant web browser. In a preferred embodiment the display device additionally supports a plug-in 3D graphics engine, such as Unity 4.5.3.

Preferably for sports game and retail embodiments, the display device is a large screen LCD TV or monitor. An exemplary display device is the Samsung Smart TV, which has display resolutions ranging from 1920×1080 pixels to 4096×2160 pixels, multiple HDMI ports, USB connecting port, and a built-in speaker system. The internal processor is a quad core CPU that is a programmable system-on-a-chip (PSOC) architecture, on board non-expandable dedicated RAM memory of 4 GB, and the communications interface supports Wi-Fi. The on board processing is capable of supporting display software, such as a web browser. However it is understood that the example is non-limiting and the processor, memory and communications interface required for the display software need not be integrated within the monitor.

An alternate preferred embodiment is the low-cost Roku 3 that can be connected by an HDMI cable to any suitable display in order to create a display device. The Roku 3 processor is a QUALCOMM Snapdragon 600 duo-core CPU with Adreno 330 GPU on a programmable system-on-a-chip (PSOC) architecture with integration for other functions such as the memory controller. The memory includes 16 GB of flash models with an internal SD card slot expansion, and 512 MB or RAM, and the communications interface supports Wi-Fi. The Roku 3 can be configured to run a plurality of software including display software, such as a web browser or other applications that enable content display.

FIG. 1 (b) illustrates an example architecture of an externally connected device 110. An illustrative example is for wearable computing eyewear, such as Google Glass, preferably paired with the compatible control device 100 via a Bluetooth connection or the like. Google- and Apple-based headsets includes a communicator 109 comprising a Bluetooth and Wi-Fi communications microchip set, mobile processor (MPU) 111, memory 105, a 5 Mega Pixel camera 101, a bone conduction transducer sensor 104, and a dedicated power supply 107. The Google Glass must be connected via Bluetooth to a control device 100 or via Wi Fi to the Internet to enable full functionality. Google Glass also includes a Liquid Crystal on Silicon (LCoS), based on an LCoS chip from Himax Technologies, LED illuminated display 108 that displays requested information to the eyeglass with the activation of touching of the sensor bone conduction transducer 104; this can be operated by visual or audio commands with compatible applications. The processor 111 is a Texas Instruments dual-core OMAP 4430 system on a chip (PSOC) architecture with integration for other functions such as the memory controller with 1-2 GB of RAM with 12 GB of dedicated flash memory. The 5 mega-pixel 115 camera gives the ability to record both still images and video recording at 720p. The memory 105 includes storage for an application 106 (“app”), which in part includes the software of the invention and third party builders. The power supply 116 includes a lithium-polymer battery the manufacturer claims to last an entire day and is not removable. This example is understood to be non-limiting however, and many variations of external sensors are possible to those skilled in the art.

FIG. 1 (b) is also representative of a smart watch, such as the Samsung Galaxy Gear S, that in order to function is required to be paired with a smartphone, FIG. 1 (a), such as the Samsung Galaxy S5. The Samsung Galaxy Gear S comprises a 1.63-inch Super AMOLED display 108 with 320×320 resolution, an 800 MHz Exynos CPU 111, 4 GB on-board storage and 512 MB RAM 105, a 1.9 MP camera 101, various sensors 104 including an accelerometer and gyroscope, Bluetooth 4.0 and LE communicator 109, and a 315 mAh battery power supply 107. We anticipate in the future that smart watches and Google Glass will not require pairing with a smartphone, and that they will include cellular transceiver capability in the communicator 109. Hence the configuration of the smart watch or Google Glass in either of 100 or 110 is understood to be non-limiting.

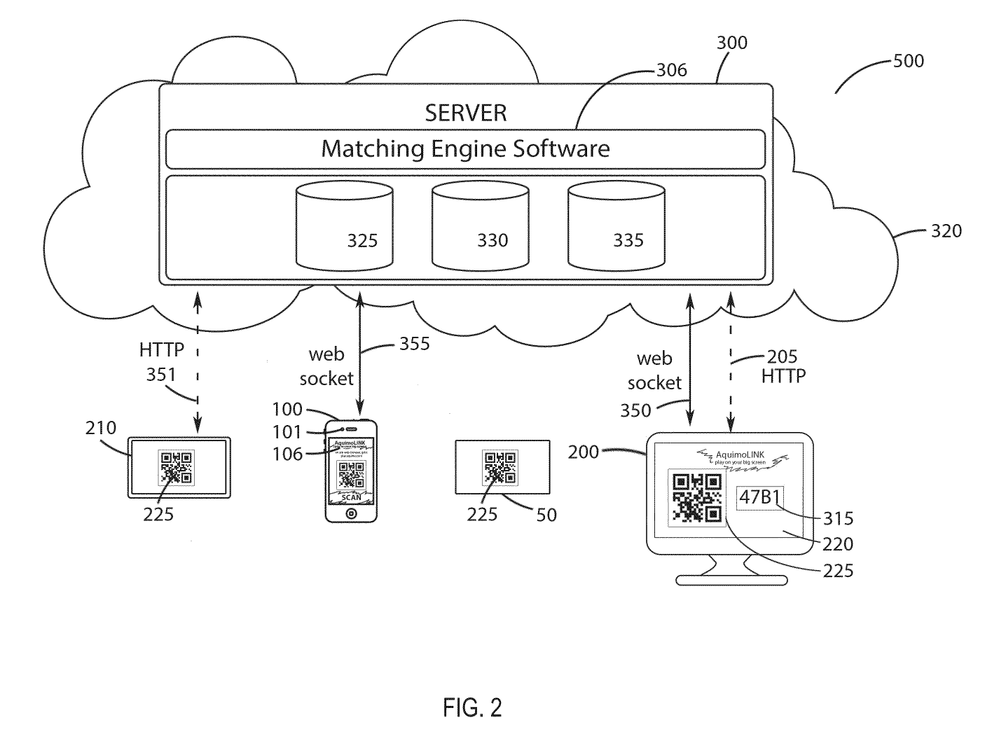

FIG. 2 illustrates a system 500 to connect to and control a display device via a control device, according to an embodiment. As shown, the three major components of the system 500 are the control devices 100, a server 300, and display devices 200. The server 300 includes a matching engine 306 that manages a plurality of users connected to the system, and the respective content for their display devices. As shown, the matching engine 306 has access to a user database 325, a code database 330, and a content database 335. The user database 325 stores login information and useful information for a user. For a sports motion game, for example, the user data 325 can include swing data for each shot made during the game, the player's current score, current level number, etc. The content database 335 can include text, graphical, video and other content for the display device 200 display software 220. The code database 330 includes the codes 315 and the respective server ports of the WebSockets 350 that connect to a display, corresponding to a particular code 315. The content database 335 contains customizable content for the respective display devices 200, given the request of the User 010 via a connected control device 100. The control device 100 includes application software 106 and a camera 101 in order to scan the code 315, which preferably is in a matrix bar code format 225 on one of the display device 200, a code display device 210, or other medium 50. Preferably, the control device 100 is connected to the server 300 via a WebSocket 355.

A WebSocket is an exemplary full-duplex Internet communication protocol over a single Transmission Control Protocol (TCP) Internet connection. The WebSocket protocol was standardized by the IETF as RFC 6455 in 2011. We anticipate that other methods of full-duplex Internet communication may be defined in the future.

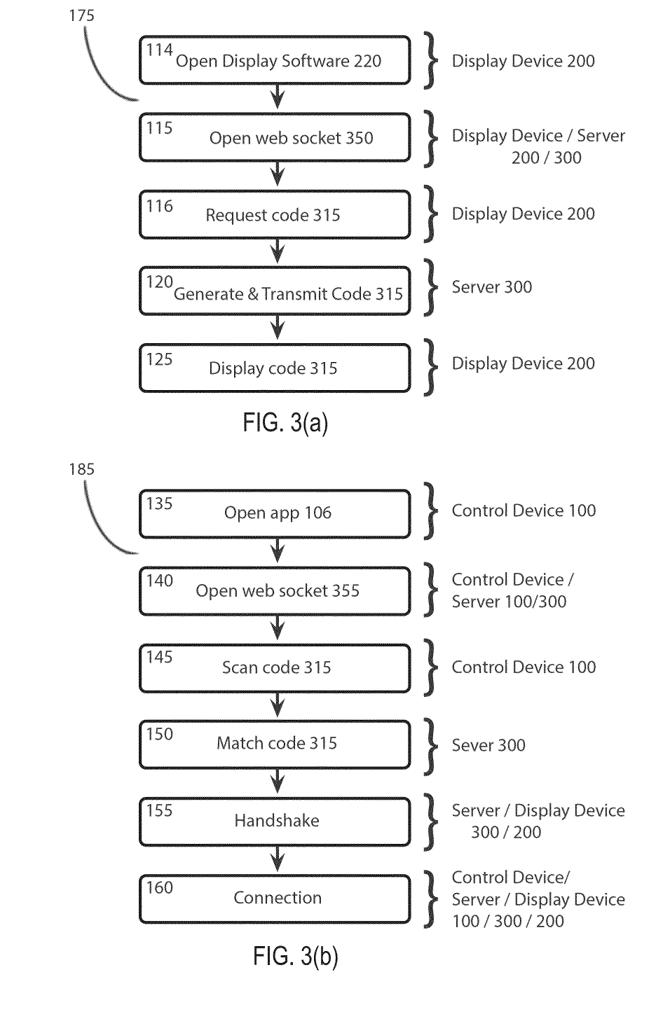

FIGS. 3(a) and (b) illustrate a method 175/185 to connect to and control a display device via a control device 100. The method comprises (1) 175 connection of the display software 220 of the display device 200 to the server 300 via a WebSocket 350, and (2) 185 connection of one or a plurality of mobile-devices 100 first to the server 300 and then via the server 300 to the display software 220 of the display device 200, wherein once connection is established the server enables control of the display software 220 by the control device 100.

The connection of a display device 200 to the server 300 is accomplished by the exemplary method 175. As shown in FIG. 3(a) initially, in step 114 preferably a user opens the display software 220 on the display device 200. Alternately the software 220 is opened automatically, upon startup of the display device for example. In step 115, the display software 220 requests a web-socket connection to the server 300, preferably via HTTP 205, wherein the socket 350 connection is established and remains open for the duration of the user session. In step 116 a request is sent to the server 300 for a code. In response, in step 120, the server 300 generates a unique alphanumeric code 315 and transmits this back to the display device 200, preferably via the web socket connection 350. In step 125, the alphanumeric code 315 is displayed on the screen of the display device 200 via the display software 220. Preferably the code is displayed as a matrix (2D) barcode code display image 225.

The connection of a control device 100 to a display device 200 is accomplished by the exemplary method 185. As shown in FIG. 3 (b), in step 135, an app 106 is opened and in step 145, the control device 100 app then requests a WebSocket 355 open between the control device 100 and the server 300. Preferably, the App 106 has the ability to scan the code 315, which is preferably rendered as a matrix barcode 225. Preferably, the app incorporates commercially available matrix barcode scanning software that makes use of the camera 101 functionality of the control device 100. Scanning the code 315 involves pointing the control device camera 101 at the matrix barcode 225, which is in the line of sight, and capturing the matrix barcode. The matrix barcode is then translated into the code 315 by the app, wherein the code 315 was originally generated by the server 300.

A differentiator of the method 175/185 is that the server generates the code 315, hence in the next step 150, the code 315 is sent from the control device 100 to the server 300 and is matched to the appropriate WebSocket that was opened for a display device. The step 150 may involve a database table lookup to match the code 315 with the web-socket 350. The next step 155 is to verify the connection via a handshake. Preferably, in an embodiment where the display software is a web page, the handshake is a re-load of the web-page with a ‘connection successful’ or web-display application ‘start screen’. At step 160 the control device 100 is connected to the display device by the respective WebSockets 350 and 355, wherein the server 300 is the intermediary. All subsequent communication is transmitted via the WebSockets 350/355 with the server 300 acting as the controller/intermediary, as illustrated in the following embodiments.

Where other known methods destroy the code once the connection is made, purportedly for security reasons, the method described herein enables multiple use of the same code 315 by a multiplicity of control devices 100. That is, while the method works well for a singular control device, a significant advantage of the inventive method 175/185 is that multiple control devices 100 may also execute the method FIG. 3(b) and concurrently connect to the same display software 220.

In the illustrated embodiment, the server 300 is cloud-based enabling global connectivity via the Internet 320. For each user, the user's control device 100 and display device 200 can be simultaneously connected to the server 300 through separate and distinct Internet connections. The control device 300 transmits data, including analyzed motion states and state sequences and other data to the server 300; in turn, the server 300 facilitates display of media at the display 200.

In a gaming embodiment, a light weight graphics logic engine, in the form of a software application, can be pushed or downloaded to a suitable display device 200 where a substantial amount of the content control logic of the matching engine 306 is encoded, and the graphics logic engine can then perform much of the work for media content display otherwise to be performed directly at the server 300.

Furthermore, the platform architecture 500 enables different content from the database 335 to be displayed on respective display devices 200 for the same application. As an illustrative example, a basketball sports game (1) in a bar, (2) at home, or (3) in a stadium may all have similar gaming logic, but the displayed graphics look and feel can be differentiated based upon variables such as, but not limited to, network IP address, display device geographic location, user geographic location, or other pre-determined identifier. These data augment the respective code database 325 and user database 330, and the matching engine software 306 has specific business rules regarding which content to display on a particular display device 200.

The code 315 corresponding to a particular display device 200 can be distributed to the user 010 via one of three methods, where it is understood that these methods are non-limiting and alternate methods can be devised by those skilled in the art. Preferably, for distribution method 1 the code 315 is graphically rendered in text and as a matrix barcode code 225 on the display device 200. However, this method may not always be convenient for the user 010.

In another embodiment, distribution method 2, the code 325 can be distributed in printed form 50 on a sticker, ticket, coaster, TV screen, or other medium separate from the display device 200, wherein preferably the code 325 is displayed as a matrix barcode 225. In a third embodiment, distribution method 3, the code 325 can be distributed on a code display device 210, wherein preferably the code 325 is displayed as a matrix barcode 225. For each of these embodiments the code 325 can be generated independent of the display device 200 by the server 300. In an embodiment for distribution method 2 and 3 the code can be generated in advance by the server. For the illustrative embodiment method 3 where the display software 220 is a web browser each code 325 can be assigned to a custom URL. When a web page 220 is opened on the code display device 210 with the custom URL, preferably the code 225 is rendered on the code display device 210, and matches one or both of the printed code 50 or the display device 200 code 325. In an embodiment, the custom URL's and their corresponding codes are stored in the code database 330. Hence the connection methods 2 and 3 enable users to connect to a particular display device 200 even though they may be physically separated from the device and unable to scan the matrix barcode code 225 directly from the display device 200 screen, as in a bar or a stadium, as illustrative non-limiting examples.

In the following description of the present invention, exemplary methods for performing various aspects of the present invention are disclosed. It is to be understood that the methods and systems of the present invention disclosed herein can be realized by executing computer program code written in a variety of suitable programming languages, such as C, C++, C#, Objective-C, Visual Basic, and Java. It is to be understood that in some embodiments, substantial portions of the application logic may be performed on the display device using, for example, the AJAX (Asynchronous JavaScript) and XML paradigm to create an asynchronous web application. Furthermore, it is to be understood that in some embodiments the software of the application can be distributed among a plurality of different servers (not shown).

It is also to be understood that the software of the invention will preferably further include various Web-based applications written in HTML, PHP, Javascript, XML and AJAX accessible by the clients using a suitable browser (e.g., Safari, Internet Explorer, Mozilla Firefox, Google Chrome, Opera, Puffin). In alternate embodiments the display software can be an application that supports various Internet communication standards, such as HTML, PHP, Javascript, XML and AJAX.

In an embodiment of 500 we implement the method 175/185 as a native application 106 for both Apple IOS and Android control devices, the matching engine 306 using Amazon web services, and the display software 220 is enabled for all major commercially available web browsers (Chrome, IE, Firefox and Safari). Preferably, an appropriate HTML 5.0 web browser is installed on the display device 200 in order to display a web page 220. For the embodiment of video game play we additionally install the Unity 3D 4.5.2 graphics engine in the web browser software so that it is embedded in the web page 220, and we also embed Unity in the application 106. We use the WebSocket API to receive data from the control device 100 and communicate with the respective server 300 and display device 200.

Specifically, in a preferred embodiment the method 175, see FIG. 3(a), is implemented as follows:

Step 114: a user opens Aquimo's website, play.aquimo.com, in a HTML 5.0 compliant browser, display software 220, on a display device 200. Upon the web page 220 opening, JavaScript code running in the browser sends a WebSocket connection request 115 to the server 300. The request is sent using the WebSocket PHP library WebSocket(wsURL) API call where the wsURL is the URL of the server 300's WebSocket host including the port number. The server 300 receives the connection request from the browser using WebSocket.onMessage( ) API and establishes a WebSocket connection with the requested browser. The server 300 and the browser 220 use the WebSocket's handshake mechanism to establish the connection.

Step 116: as soon as the browser 220 gets the WebSocket connection opened, it sends a message to the server 300 requesting a unique code 315. The request message is sent using the WebSocket WebSocket.send( ) API Java Script call in the browser 220.

Step 120: the server 300 receives the message requesting the code 315 using the WebSocket.onMessage( ) API and the matching engine software 306 generates a unique 5-7 digit alphanumeric scan code using a random code generation API, preferably using rand( ) API in PHP. The matching engine software 306 compares the newly generated scan code with the codes corresponding to existing WebSocket connections, stored in the display code database 330, to guarantee the uniqueness of the newly generated code 315.

Step 125: the code 315 is sent to the browser using the WebSocket.sendMessage( ) API. The web browser receives the message with the code 315 using the WebSocket.onMessage( ) API. It then displays the scan code on the web page and converts the scan code to a matrix barcode code display image using the matrix barcodescan Codes library (a third party matrix barcode scan code generator library in JavaScript, licensed from MIT).

These steps complete a persistent WebSocket connection between the display device 200 and the server 300 wherein the code 315 uniquely identifies requests coming from the particular browser 220 on the display device 200 to the server 300.

In a preferred embodiment the method 185, see FIG. 3(b), is implemented as follows:

Step 135: the user launches the app 106 on the control device 100 (Apple iPhone or an Android device in this illustrative example, but the device 100 is non limiting).

Step 140: upon the launch 135, the App 106 opens a WebSocket connection with the server 300. On Apple devices, this connection is made using the SRWebSocket library's SRWebSocket.open( ) API. On Android devices, the connection is made using the AutoBahn's library WebSocketConnection.connect( ) API.

Step 145: in the app 106, the user navigates to a screen with an option to connect to the display software 220 on the display device 200. On tapping the ‘scan matrix barcode code’ button, the app scans the matrix barcode code (scan code 315) by pointing the phone to the matrix barcode 225: On Apple devices, the scan is done using built-in camera functionality with an option to scan a matrix barcode 225. On Android devices ZBar, a third party library, is used to scan the matrix barcode 225. Optionally, the user may enter the alphanumeric code 315 instead of scanning it.

Step 150: after scanning the code, the App 106 sends the code 315 to the server 300 using SRWebSocket.send( ) or WebSocketConnection.sendTextMessage( ) APIs. The server 300 receives the code 315 from the control device 100 and the matching engine software 306 matches the connection request from the device 100 to the already established connection from the browser 220 with the same code 315 stored in the display code database 330.

Step 155: the App 106 on the control device 100 sends a request to server 300 to reload the contents on the browser 220 on the display device 200. This completes 160 a live connection from the device 100 to the display device 200, via the server 300 wherein the live connections are enabled by WebSockets.

It is to be understood that the forgoing disclosure is non-limiting such that the connections can be made in a different order. For example, the device 100 can connect to the server 300 first, using steps 135 and 140 of the method 185, and then the display software 220 and display device 200 make the connection following the method 175. In an illustrative example of this embodiment, the user can launch the App 106 first and may be prepared to scan the matrix barcode code 225 before launching the display software 220. Once the display software 220 opens and displays the matrix barcode code 225 then the app 106 can scan that code.

Furthermore, multiple variations are possible for the order of the steps in the method 175 and 185, and it is understood that the method and steps are described herein are illustrative and non-limiting. For example in method 185, the App 106 may enable scanning of the code 225, Step 145, before opening a WebSocket step, Step 140. Furthermore, the display software can be any software applications that supports open standard Internet protocols and is not limited to be a web-browser. In a preferred embodiment disclosed herein the Internet protocols can be JSON and WebSockets; however, it is anticipated that these standards my change and hence the protocols are understood to be non-limiting.

The method 175/185 is extensible to a plurality of software and hardware systems. An exemplary embodiment is the connection and control of a display device 200 that is an iPad or Nexus tablet, wherein the display software is a native application, the display app, written in the iOS SDK 8.0 using Xcode 6.0 for IOS or SDK 4.4 KitKat for Android. The steps for connecting the display device to the server similarly follow the method 175, where the following example SDK calls are for IOS and are understood to be non-limiting:

114 The user opens the native coded display app 220 on an iPad or a similar device.

115 The display app 220 opens a web socket connection with the Server 300. The connection is requested using SRWebSocket library's SRWebSocket.open( ) API. The Server 300 receives the connection request from the display device using WebSocket.onMessage( ) API and establishes a web socket connection with the requested App. The server and the display app use the Web Socket's hand shake mechanism to establish the connection.

116 As soon as the display app gets the web socket connection opened, it sends a message to server 300 requesting a code. The message is sent using web socket's WebSocket.send( ) API from a Java Script code in the browser. The Server 300 receives the message using WebSocket.onMessage( ) API and generates a unique 5-7 digit alphanumeric scan code using a random code generation API, preferably using rand( ) API in PHP. The generated scan code is sent to the display app 220 using WebSocket.sendMessage( ) API.

125 The display app receives the message with the code using the WebSocket.onMessage( ) API. The display app then displays the scan code on the tablet screen by converting the scan code to a QR code display image using qrscan codes.

Any control device 100 with suitable software can then scan the code of the display app 220 and, via the method 185, connect to and control the tablet display device 200. Where it is understood the example embodiment is illustrative of the extensibility of the method to connect to and control a multiplicity of display devices and is non-limiting.

The system 500 and method 175/185 therefore enables seamless remote control of display software 220 on a display device 200 via a control device 100. The following three example further illustrate preferred embodiments for (1) remote control of web page navigation, (2) remote control of a video game, and (3) remote control of an app. Wherein the first example embodiment is for control of a web page, the connection and control can be to any display software that supports appropriate open standard Internet protocols. Specifically, example (2) is an embodiment for connection and control of a gaming graphics engine which preferably is downloaded to a suitable web-browser but can also be installed as a stand alone application on the display device. Example (3) is remote control of an IOS or Android App on a tablet display device wherein there is no web browser.

(1) Remote Control of Web Browser Navigation

A web page is controlled by the control device 100 as follows wherein WebSocket connections are first established between the App 106 and the web-enabled display device 200 via the server 300 using the method 175/185 disclosed herein. As an illustrative example embodiment, a user taps on ‘Hello World’ (or other programmed text link or menu item) on the control device 100 App 106 screen. As a result, the App creates a view for the next screen via the call:
viewFlipper.addView(screen.getView( ));
   and then sends a request to Server in the form of JSON (JavaScript Object Notation), containing key and value pairs of—Scan code, Client, Task (helloWorld), pageObject, fnId, params, EmailID, ProfileType, pageID via WebSocket connection: sendWebSocketcallForScreenNavigation( ).

This JSON object is then sent to the server 300 via:

```
Message msg = new Message( );
msg.what = webService.getId( );
    if (bundle != null)
    msg.setData(bundle);
msg.replyTo = new Messenger(new ServiceResponseHandler( ));
messenger.send(msg);
```

The server 300 receives the data from the device wherein the received data is descan coded as follows:

public function onMessage(IWebSocketConnection $user,
IWebSocketMessage $msg) {
$message = $msg->getData( );
$messageObj = json_descan code($message); }

As necessary, data received at the server 300 can be processed and/or saved in the database 330. The server 300 then sends these data to the browser 220 on the display device 200. As the next step the data is sent to the web browser(s) connected with the device via:
currentUser->sendMessage($msg);

The browser receives these data and automatically navigates to the requested screen. That is, based on the task request sent by the control device 100 in JSON format, the browser takes an action:

```
function performAction(data) {
    // switch according to task received
    switch(data.Task) {
        case “helloWorld”:
        HelloWorldScreen.showScreen( );
    break; }
```

This preferred embodiment creates a new screen called ‘HelloWorldScreen’, which is then shown to the user in the browser display software 220 on the display device 200. While it is understood this illustrative example is a simple case, those skilled in the art may use the methods 175/185 and system 500 for very complex manipulation of one (or multiple) web page(s) 220 on display device(s) 200 by one or multiple control device(s) 100.

(2) Remote Control of a Video Game

Following the method 175/185 a video game is controlled by the motion of the control device 100 as follows, wherein the server 300 is a game server. We assume the suitable App 106 is programmed with an integrated graphics engine, such as Unity, and similarly a graphics engine such as Unity and light weight gaming logic engine is installed in the display software 220, such as a web page, on the display device 200. In an alternate embodiment, Unity maybe downloaded and installed as a stand alone application in which case Unity is the display software 220, wherein the stand alone application incorporating Unity is programmed with an SDK which includes WebSockets and JSON, or similar Internet communication protocols.

WebSocket connections are first established between the app 106 and the display device 200 with the gaming software using the method 175/185 disclosed herein. To control the game the user may touch active links or graphical elements in the app 106, similar to control of the web page described herein. Alternately, in a preferred embodiment the user moves the control device 100 in a motion that corresponds to a video game action, such as a basketball free throw shot or an American football pass. Prior art to Jeffery et. al US patent application PCT/US2012/061209 “Method and System to Analyze Sports Motions Using Motion Sensors of a Mobile Device”, priority date, Oct. 25, 2011 and Komourous-King et al. U.S. Ser. No. 14/472,164, “Method of Using Motion States of a Control Device for Control of a System”, priority date Aug. 28, 2014 provide methods for analysis of sports motions by a control device and motion state control of complex systems, such as a video game, by a control device. These inventions PCT/US2012/061209 and U.S. Ser. No. 14/472,164 are our preferred methods for motion analysis and motion control, and the content of which is incorporated herein by reference in its entirety.

Using the motion capture algorithm, and based on the control device 100 motion sensor data, the app 106 calculates the force, angle Y and angle X to input to the graphics engine, at both the control device 100 and display device 200.

Similar to the web-page remote control described herein, the app 106 sends the request to the game server 300 in the form of JSON, containing code and value pairs of—Scan code, Client, Task (action), gameObject (Camera), fnId (startGameAnimation), params (“force|angleY∥angleX”), EmailID, ProfileType, GameID via WebSocket connection: sendWebSocketcallForScreenNavigation( ). Where sample values for “force|angleY∥angleX” may be “74|179.5|225” respectively

This JSON object is then sent to the game server 300 and to the Unity engine running locally on the control device 100:

```
Message msg = new Message( );
msg.what = webService.getId( );
    if (bundle != null)
        msg.setData(bundle);
        msg.replyTo = new Messenger(new
        ServiceResponseHandler( ));
messenger.send(msg);
```

The local unity engine in the app 106 executes the gaming algorithm based on these data and shows the appropriate gaming animation on the control device 100.

The Game Server 300 receives the data from the control device 100 and these data are descan coded as follows:

```
public function onMessage(IWebSocketConnection $user,
IWebSocketMessage $msg) {
    $message = $msg->getData( );
    $messageObj = json_descan code($message); }
```

Optionally, these data are saved to the database 325. The game server 300 then sends these data to the display software 220 on the display device 200:
currentUser->sendMessage($msg);

The display software 220, preferably a web browser, receives these data and sends them to the locally installed Unity engine to execute the game play algorithm. The Unity engine executes the gaming algorithm based on the data and shows gaming animation via the following logic:

```
function performAction(data) {
    // switch according to task received
    switch(data.Task) {
        case “action”:
        var params = data.params;
        var gameObject = data.gameObject;
        var fnId = data.fnId;
        u.getUnity( ).SendMessage(gameObject, fnId, params);
    break; } }
```

The result is the game animation is played on both the control device 100 and the display device 200, wherein the remote control is facilitated by the gaming server 300. Note that the example is illustrative and non-limiting and it is to be understood that many variations of this example are possible by those skilled in the art. For example, the output on the control device 100 resulting for the motion is not required to be the same as the output on the display device 200.

(3) Control of a Display Application

The inventive systems and methods disclosed herein are not limited to control of web pages or games. In the following example, the control device 100 is used to control play of video on a display device 200.

WebSocket connections are first established between the app 106 and the display software 220 using the method 175/185 disclosed herein. The user next taps on a “Play Video” widget or the like enabled by the app 106 on the control device 100. The “Play Video” widget embeds the action name to play a video as well as the name and location of the video to be played. In an alternate embodiment, the server 300 can select the video from the content database 335 via business logic rules.

The app 106 sends a “Play Video” action message to the server 300. Similar to the prior examples, the message is sent via a request in the form of JSON, containing key and value pairs of Scan code, Action, and Contents:

```
NSDictionary *taskList = @{@“Action” : @“Play Video”,
@“Video Name” : @“sampleVideo”};
NSData * jsonData =
[NSJSONSerialization dataWithJSONObject:taskList
options:NSJSONReadingMutableContainers error:nil];
NSString* myString;
myString = [[NSString alloc]
initWithData:jsonData encoding:NSASCIIStringEncoding];
    if([SocketClient sharedClient].ISCONNECTIONOPEN)
    {
        [[SocketClient sharedClient] sendMessage:myString];
    }
```

The server 300 receives the “Play Video” message, and the received data is coded in the same manner as the last two examples. The server 300 matches the message request with the connected descan coded and sends the message to the display software 220:
currentUser->sendMessage($msg);

The display software 220 receives the message and then executes the requested action, i.e. Play Video:

```
  -(void)webSocket:(SRWebSocket*)webSocketdidReceiveMessage:
  (id)message;
    {
      NSData* data =
      [message dataUsingEncoding:NSUTF8StringEncoding];
      NSDictionary *dictInfo =
      [NSJSONSerialization JSONObjectWithData:data
      options:NSJSONReadingMutableContainers error: nil];
      NSLog(@“SocketInfo:%@”,dictInfo);
      if([[dictInfo objectForKey:@“Action”]
      isEqualToString:@“Play Video”])
      {
      [self playVideoOfName: [dictInfo objectForKey: @“Video
      Name”]);
      }
    }
-(void) playVideoOfName:(NSString*)videoName
    {
      NSString *path = [[NSBundle mainBundle]pathForResource:
      videoName ofType:@“mp4”];
      moviePlayer = [[MPMoviePlayerViewController
alloc]initWithContentURL:[NSURL fileURLWithPath:path]];
      [self presentModalViewController:moviePlayer animated:NO];
    }
```

The above code segments are for remotely controlling the playing of video on an Apple iPad or iPhone display device via an iPhone control device; however, it is to be understood that code to accomplish substantially the same functionality could be developed for any number of different types of devices and operating systems without departing from the spirit and scope of the present invention. Furthermore, it is to be understood that this example is not limited to remotely controlling and playing a video, and a many different control embodiments maybe derived by those skilled in the art without departing from the spirit and scope of the present invention.

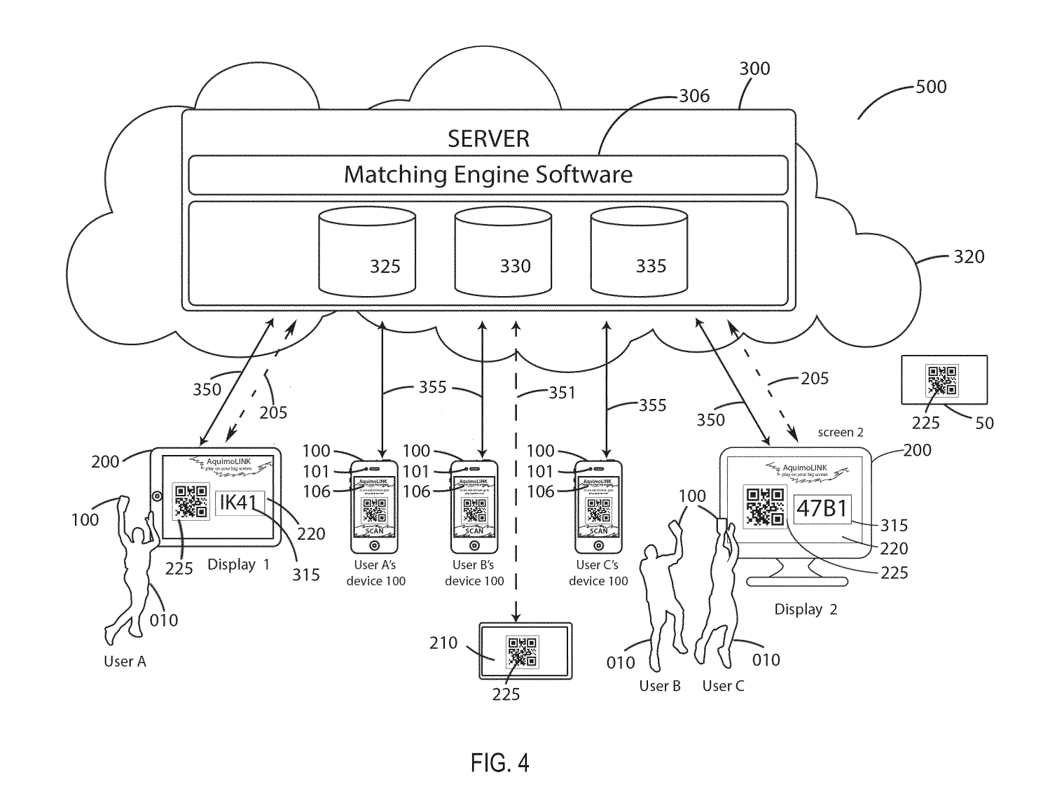

A significant aspect of the present invention disclosed herein is that the method and system is extensible and scalable to multiple simultaneous users. FIG. 4 illustrates an embodiment of the system 500 with multiple users 010 and displays 200 connected simultaneously to display devices 200 via the server 300. In the illustrative example User A is connected to Display (Device) 1 and Users B and C are connected simultaneously to Display (Device) 2. In the illustrative example User A scanned the code 225 on the screen of the Display 1, whereas the Users B and C optionally (1) scanned the code 225 on the screen of the Display 2 or (2) the code 225 on the printed media 50, or (3) the code 225 on the code display device 210. Each of these three methods enables connectivity of the respective users A, B and C control devices 100 to the correct display devices via the method 175/185 described herein. FIG. 4 is illustrative, and it is understood that the system and method of this embodiment are not limited to three users. That is, the system illustrated in FIG. 2 and FIG. 4 is scalable to millions of simultaneous users given server technology currently available with databases stored in a single geographic location, and can scale to 100 million or more users given data replication in major global geographies.

In a preferred embodiment the server 300 and databases of the system 500 are implemented using Amazon Web Services (AWS) cloud computing. We use the Amazon DynamoDB database to store and process all the user and gaming data. The DynamoDB database is a highly scalable distributed database environment with no known limitations on the size of data or number of transactions per second. The Amazon DynamoDB database is hosted in the Amazon Cloud environment in its worldwide locations. The Amazon DynamoDB database replicates data across multiple data centers to ensure reliability and in an embodiment these data are distributed globally via Amazon's global data centers, based on the user demography.

The method 175/185 and platform 500 makes use of the WebSocket protocol RFC 6455 to support connectivity between the control devices 100 and display software 220 on the display devices 200. A WebSocket connection is established using a socket on the WebSocket port of a server. A WebSocket port is a TCP/IP port that is open and listening for requests on the server. The port is opened using WebSocktet library's stream_socket_server( ) method in PHP, and the getResources( ) method is used to retrieve the sockets that are currently active. The Select( ) method is used to detect an incoming message on a socket. Each user connection requires two ports, one each for the device and the display software, and each WebSocket port can support more than 1000 sockets, i.e. user connections. In a preferred embodiment Linux based server instances in the Amazon Cloud are used to host WebSocket connectivity. Each such server instance can support hundreds of WebSocket ports. Hence, the system can be scaled by adding server instances, wherein the ports are added to support user demand. For example, 50 server instances with 5,000 total ports, can be configured to support 5,000,000 simultaneous user connections. Replicating this architecture and the DynamoDB database to the 37 existing global Amazon sites enables scalability to 185 million simultaneous users, as an illustrative example. The example is non-limiting however, and the method 175/185 and system 500 has no known scalability constraints.

The method and system described herein has many applications which may be derived by those skilled in the art. The invention is further illustrated via additional examples:

Multi-User Sports Game Connection and Control

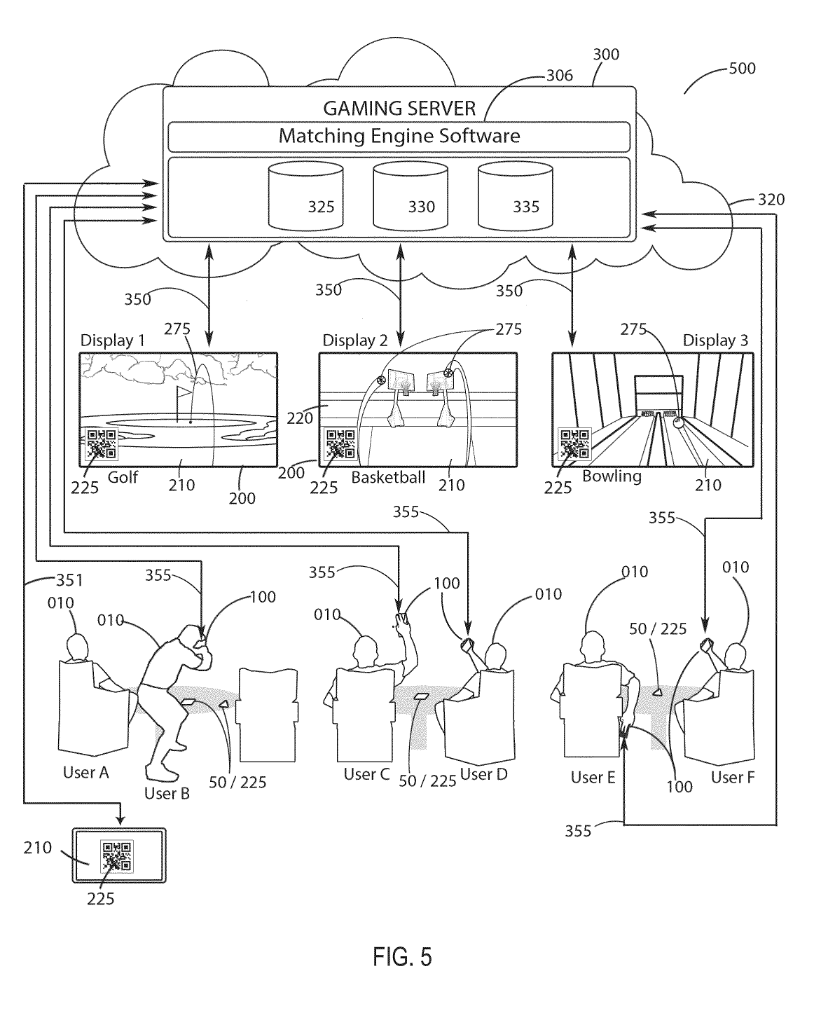

FIG. 5 is an exemplary embodiment of the system 500 for sports gaming, where the illustrative example is for game play in bars or restaurants. However it is understood the example is non-limiting and the game play can be in any location, such as homes, offices, hotels or airports. Prior art to Jeffery et. al. discloses a “Web-Based Game Platform with Mobile Device Motion Sensor Input,” patent application Ser. No. 13/875,179, filing date May 1, 2013, which is herein incorporated by reference in its entirety.

FIG. 5 illustrates multiple display devices 200 connected to local wireless LANs. The displays 200 may be in the same geographic locations or different locations, such as various bars, restaurants, offices, hotels or homes. The displays 200 connect to the server 300, which in the preferred embodiment is a gaming server, via the method 175 wherein a unique code 315 for each display is generated by the server 300 and, preferably, a corresponding matrix barcode code 225 is rendered on the display devices 200, and following the method 175 a WebSocket connection is setup between each display and the server 300. In the exemplary illustration FIG. 5, Users 010 A and B connect 355 to Display 1 200 via the same control device 100. Users C and D, connect 355 to Display 2 via different control devices 100; and similarly Users E and F connect 355 to Display 3 via different control devices 100. Wherein, each display device 200 connection 350 is made following the method 175, and each control device 100 connection 355 is made following the method 185.

In the exemplary illustration FIG. 5 the Users 010 play sports games such as, but not limited to, golf, basketball, American football, bowling, tennis, fishing, soccer, hockey and bean bag toss. In an embodiment, once connected to the system 300, users 010 control the display devices 200 following the method of U.S. Ser. No. 13/875,179, and in playing these games in an embodiment use their control devices to simulate sports motions, which are analyzed and data sent to the game server 300.

Preferably, the code database 330 contains the code assigned to a respective display 200, the port of the WebSocket 355 connected to the display, and additional data pertaining to the display. These data may include, but are not limited to, the geographic location of the display, if the display is in a bar or restaurant, for examples. An embodiment of the invention incorporating the geographic location awareness of the display is illustrated in FIG. 5, wherein the matrix barcode code 225 is distributed in advance to the geographic location on printed media 50, or using a low-cost code display device 210. The embodiment of the matrix barcode code 225 separate from the display device 200 is useful when it is inconvenient for the user to scan the code 225 directly from the display device 200 screen.

In an embodiment where there are multiple display devices in a particular location, the method 175/185 may be used in conjunction with location awareness of one of the user control device 100 or the display device 200 in order to connect the user to the preferred display. In the embodiment of a matrix barcode code printed on a ticket or coaster, for example, a user scanning the code is understood by the matching engine software 306 of the server 300 to be connecting to the display device 200 in the local geographic proximity, wherein the location of the display device are known in advance. In an alternate embodiment, the matrix barcode code 225 may additionally encode Display 1, Display 2, or Display 3 (the display identifier), for example, and the display identifiers are stored in the code database 330. Hence, scanning a printed coaster on a table or sticker, for example, can seamlessly connect the users to the preferred display device in local geographic proximity.

Location awareness of the control device 100 is enabled by calls to the gpsOne API via the App 106. GPSone is a cellphone chipset manufactured by QUALCOMM that allows cell phones to more accurately plot a user's position, using a technology referred to as A-GPS or Assisted-GPS. Alternately, the control device 100 and display device 200 locations can be identified by IP, HTTP GET request is made by the device to URL <ip-api.com/json> which returns the nearest possible latitude and longitude of the device and the corresponding address, which might not be the exact location of the device. Current IP location awareness technology may or may not be accurate, however A-GPS is fairly reliable, and we anticipate the technology for both will improve in the near future.

In an alternate and preferred embodiment, the matrix barcode code 225 corresponding to a particular display device 200 is displayed on a low cost code display device 210. Users scan the matrix barcode code 225 on the code display device in order to connect to the corresponding display device 200. Preferably, the IP addresses of the code display device 210 and the corresponding display device 200 are stored in the code database 330, wherein an appropriate app or web page is loaded onto the code display device 210. The method 175 is modified so that step 125 simultaneously displays the code 225 on the code display device 210 and the display device 200, wherein the matching logic engine 306 on the server 300 uses the method and embodiment for remote control described above to simultaneously display the code 225 on the code display device 210 and the display device 200 code.

Furthermore, in an embodiment the content for a display 200 may be defined dynamically via a general control device 100 and app 106. However in a alternate embodiment the app 106 on the control device may be customized to request specific content for the display 200, such as a bowling game for example or via a different app for a basketball game, for example. In an embodiment, the content accessible by the control device 100 app 106 and the display device 200 can be determined by the location of the display and/or control device. For those with skill in the art, these location dependent content variations are straightforward to implement via business logic rules in the matching engine software 306 given the location of the respective display devices 200 and/or the control devices 100.

Simultaneous Connection and Play on a Display Device in a Stadium

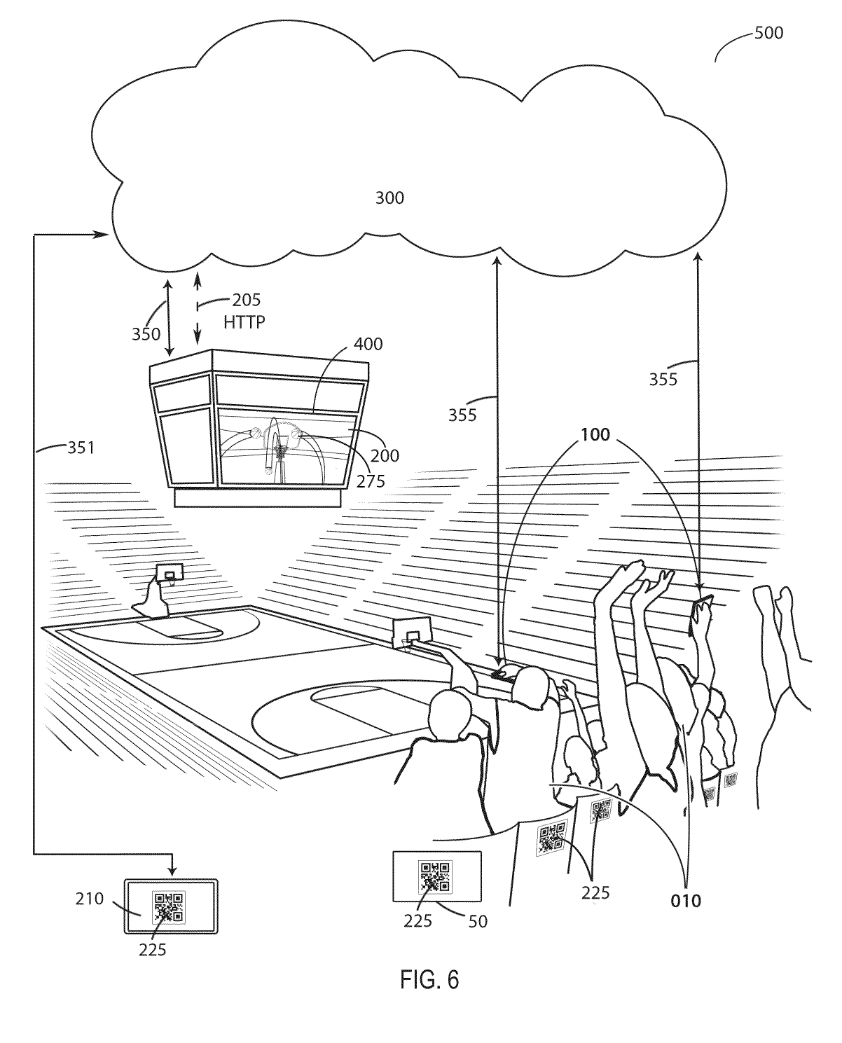

FIG. 6 is an exemplary illustration of many (1,000's or more) users 010 simultaneously utilizing the same display device 400. In exemplary illustration the display device 400 is a very large display, such as a JumboTron™, in a basketball stadium. The JumboTron (a.k.a. Jumbovision) are known as the largest non-projection video displays, commonly used in stadiums, marketing screens, scoreboards and at big events. These screens were originally made of 16 or more small flood-beam CRTs (cathode ray tubes) and ranged from 2 to 16 pixels. The newest model JumboTron and Jumbovision screens are now large-scale LED displays. Both the newer and older versions enable multiple device connections and can be connected with various audio and video formats. These systems can display almost any type of format connected with any of the following: VGA, DVI, HDMI and Coaxial with USB connectivity on the latest systems. That is, JumboTrons can project computers, smartphones, Blu-ray players, and other digital devices. Hence, it is straightforward to display a display software 225 of the invention, such as a web-page in an embodiment, on a JumboTron, and create a display device 400 for 1000's of simultaneous users. However it is understood that the example is illustrative and non-limiting.

The JumboTron has resolution limitations and hence due to the distance of the users 010 from the display device 400 it is not feasible to scan the code 225 on the display device 400. Preferably in this embodiment, the users 010 connect to the display using the method 175/185 wherein a code 225 is distributed in advance via printed media, on a ticket or sticker 50, for example. In another embodiment, users 010 may connect via a code 225 on a convenient code display device 210. The mode of play for the embodiment illustrated in FIG. 6 is for users 010 to play simultaneously on the large display 400, making basketball free throw shots as an illustrative example. The gaming server 300 keeps track of the respective users shots and “winners” are determined by the rules of the game, which may be consecutive baskets in 60 seconds for example.

Note that the game play on the display device 400 is not limited to users 010 in the stadium. In an embodiment of a live telecast event the code 225 could be presented to users 010 external to the stadium, in an advertisement on TV as an illustrative example, wherein users in homes, bars, restaurants, hotels or elsewhere scan the code 225 on their respective TV screens and can simultaneously play on the display device 400 in the stadium from their respective geographic location. Hence, in this embodiment, the inventive method and system is applicable to millions of simultaneous users in different geographic locations.

Multi-Media Presentation Connection and Control

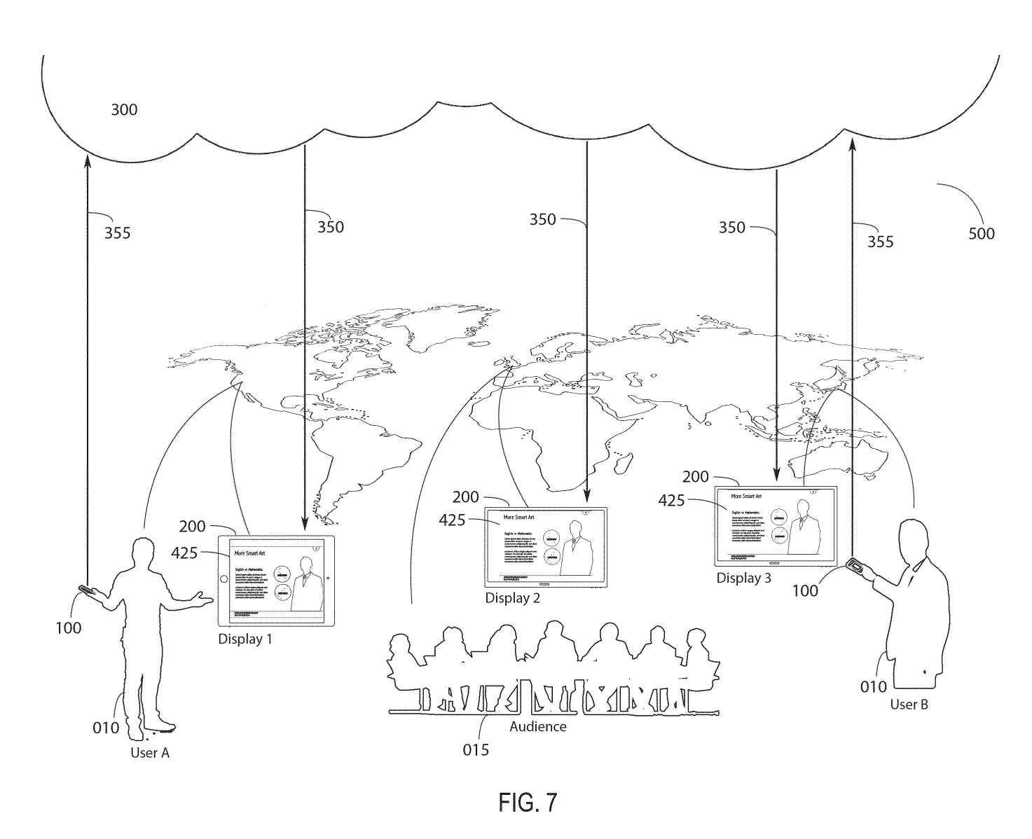

The method described herein has many applications other than computer games. FIG. 7 is an embodiment of the method 175/185 and system 500 for control of an interactive multimedia presentation 425. In the illustrative example the exemplary multimedia presentation comprises text, image, and video content presented on display devices 200, where the example is understood to be non-limiting. Similar to the embodiments described previously, the presentation 425 can be custom coded on a web page, or can be enabled via programming a pre-loaded graphics engine such as Unity, or can be a custom app which preferably supports WebSockets and other Internet protocols such as JSON.

In an illustrative embodiment, we assume the display device 200 supports the method 175/185 and system 500 such that touching the screen of the app 106 on the control device 100 results in control of the presentation 425 on the display device 200: navigating foreword and back, displaying video, highlighting text etc., as illustrative non-limiting examples.

As previously disclosed herein, the matching engine software 306, see FIGS. 2 and 4, connects the control devices 100 to the display devices 200 via WebSockets 350 and 355, whereby the matching includes a database 330 look up of codes corresponding to respective sockets 350 for a particular display device 200. In a preferred embodiment, the socket connections 350 and 355 are separate and distinct so that additional processing via computer programs for specific applications of various embodiments can be enabled at the server 300, display device 200 or control device 100, and their respective data transmitted via the WebSockets 350 and 355. Hence, for experts in the art the embodiment of the system 500 in the exemplary illustration FIG. 7 is straightforward to implement given the illustrative example embodiments previously disclosed herein using JSON or other distributed programming language and protocol.

FIG. 7 is an exemplary illustration of two users, User A in San Francisco and User B in Tokyo, simultaneously controlling a multimedia presentation 425 on display devices 200 for an audience 015 in London and in the respective User A and User B locations. In the illustrative example embodiment, the three display devices comprise a cluster of displays in different geographic locations. However, it is understood the example is non-limiting and there is no technical limitation of the method 175/185 and system 500 for the number of users or the number of display devices that can simultaneously connect to and be controlled by one or multiple control devices 100.

The method 175/185 and system 500 enables a single user 010 or multiple users to connect to and control the multi-media presentations 425 in multiple different locations simultaneously. In a preferred embodiment, a custom URL is used for the presentation 425 where the same code 225, the group code for the cluster of displays for the multimedia presentation, is displayed on each respective display device 200, enabling User A and User B to connect via the method 185, wherein the matching engine software 306 enables both User A and User B's control devices 100 to simultaneously connect to and control the three display devices 200 in the cluster, see FIG. 7. In an alternate preferred embodiment the server 300 generates a unique code for each display device, wherein specific display devices are assigned to a group, which in an embodiment is stored as a table in the database 325. The matching engine software 306 includes business rules so that a control device scanning a code corresponding to one display device in a group is connected via the method 175/185 to all displays in the group. In an alternate embodiment, the multimedia presentation app is distributed via a standard URL, the code is scanned by User A to connect User A to Display 1, and the code 315 is manually typed into the multimedia presentation 425 start screen on the respective display devices 200.

Retail Store Display Connection and Control

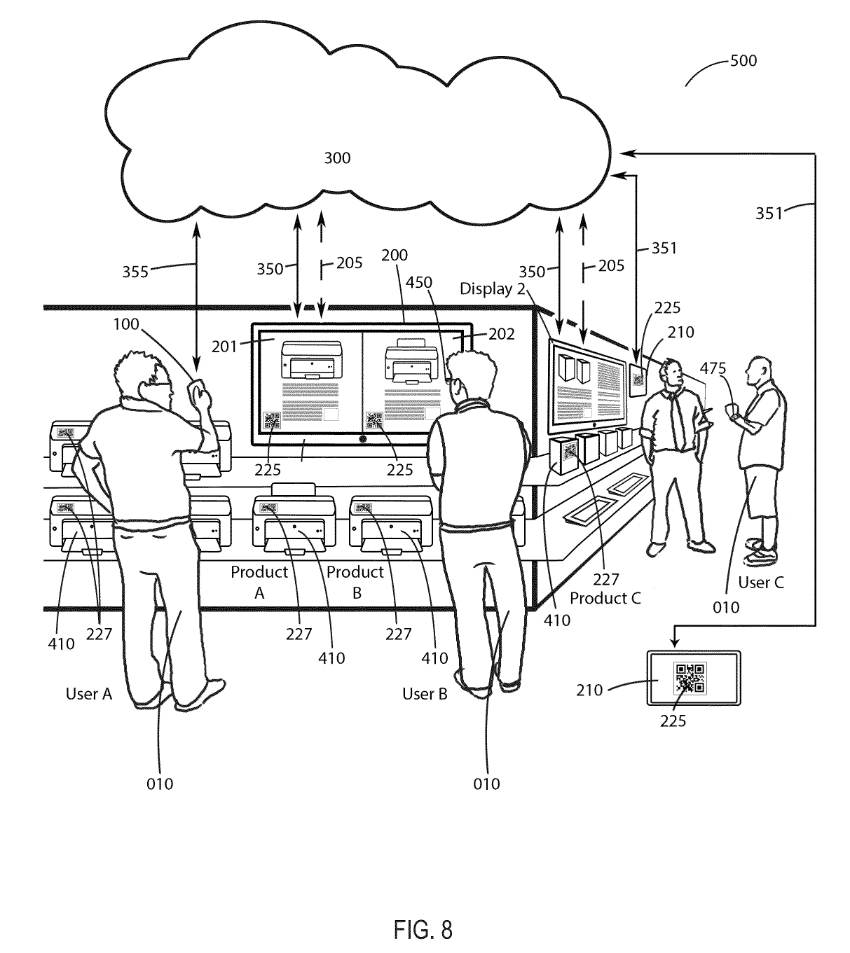

FIG. 8 is an exemplary illustration of an embodiment of the invention in a retail store. In this embodiment the system 500 is configured so that various product information is loaded into the content database 335. Users 010 may then connect to the display devices 200 located in the store, preferably in the similar location to the products 285. Users with control devices 100 such as exemplary smart phones, Google glass 450, or smart watches 475.

In as preferred embodiment, the retail software application 106 and matching engine software 306 on the server 300 is programmed in conjunction with the respective control devices 100, wherein the app 106 matrix barcode reader can also read product 410 UPC bar codes 227. In an embodiment, users 010 scan codes 225 for a display 200 and additionally scan product UPC codes 227. In an embodiment, the server 300 then serves customizes content from the database 335 customized for the respective display device 200 with specific information on the product 410, which may be specifications, diagrams, videos, audio clips or animations of the product, and/or testimonial videos as non-limiting examples.

FIG. 8 is an illustration demonstrating the inventive method and system in a preferred retail embodiment. In FIG. 8, Display 1, 200, has two different applications 201 and 202, which in an embodiment could be HTML 5.0 web pages or other custom programmed display software, sharing the same processor and memory of the display device 200. The screens 201 and 202 have different and unique codes 225, wherein in a preferred embodiment the screens 201 and 202 are different web pages. In FIG. 8, User A is interested in Product A and User B is interested in Product B. Preferably, User A scans the code 225 on the Display 1, 200. His respective control device 100 is then connected to 201 via the method 175/185. As a next step he scans the UPC code 227 for Product A and product information content is displayed on the screen 201 and optionally on the control device 100, wherein the content can be controlled (navigated) by the User A control device 100. Similarly User B may first scan the UPC 227 for Product B and then the code 225 on the screen 202 via Google Glass 450. The customized content for Product B is then displayed on the screen 202, which is controlled by User B's Google Glass control device, 450, wherein touching the Google Glass bone transducer enables navigation.

FIG. 8 is also an exemplary illustration of a third User C connecting and controlling a second Display 2, independent of Display 1, wherein the control is via a smart watch 475 scanning the code 225 on a code display device 210 so as to connect to the display via the method 175/185.

Note that previous embodiments disclosed herein have focused on a single display software application 220 on a display device 200, or on multiple display devices 200, which in various embodiments may be controlled by one or more users. FIG. 8 is an exemplary illustration of multiple users (two in the example of User A and User B) controlling multiple display software applications 220 (two different web-pages in the illustrative embodiment example) on the same display device 200. Where it is understood that the number of Users or the number of display software applications 220 on a display device 200 is non-limiting. Furthermore, the order of connecting to the display 200 via the code 225 or scanning the UPC 227 is non-limiting.

As an illustrative example embodiment, an HTML 5.0 compliant web-browser supports multiple WebSocket connections 350, one each to the web-pages 201 and 202 for example, so that for experts skilled in the art implementation of the illustrative embodiment is straight forward via JSON or other distributed programming language and protocol. Furthermore, as disclosed herein the architecture of Google Glass or an Apple Watch is not significantly different form the control device 100 and 110 illustrated in FIG. 1, and programming the inventive method 175/185 for these mobile devices via Java using the Android Software Development Kit (SDK) for Google Glass (similar to Android mobile phone) or IOS SDK for Apple Watch (similar to iPhone), or other appropriate programming language, is also straightforward for those skilled in the art.

Connection to and Control of a Digital Shopping Cart

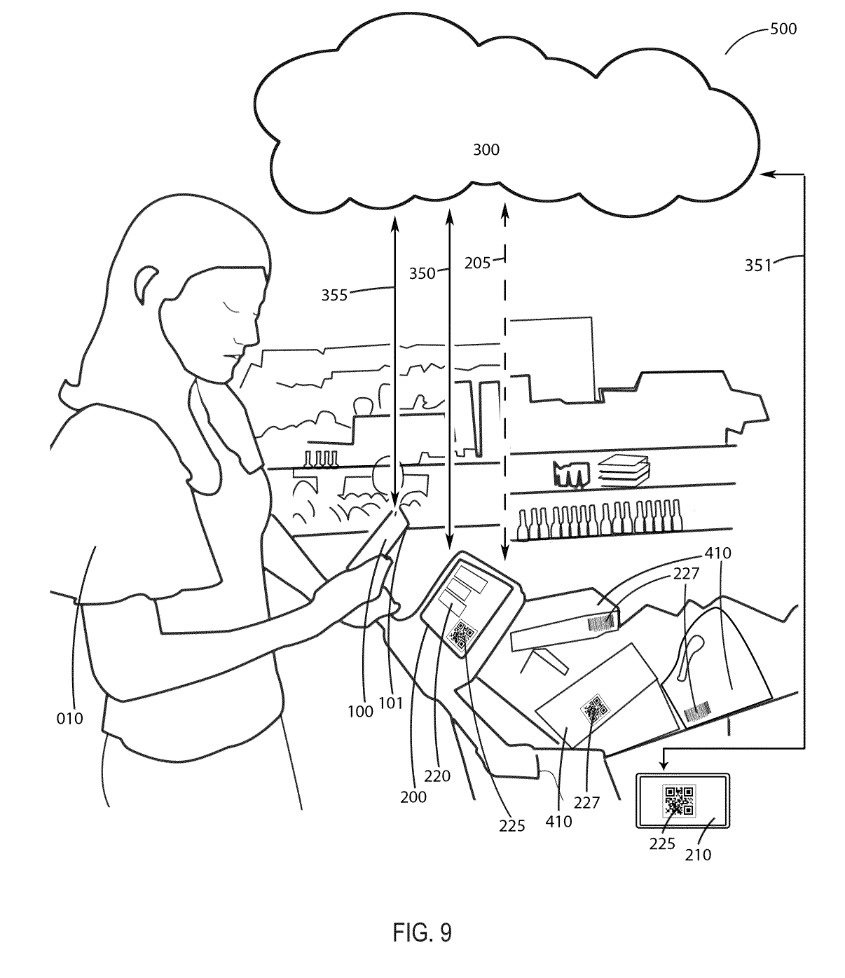

FIG. 9 is an exemplary illustration of an embodiment of the invention for a retailer, such as a grocery score. In the embodiment shopping carts are equipped with suitable display devices 200 such as an Apple iPad or Samsung Galaxy Tab. Preferably, display software 220 that is a web page or custom App that supports standard Internet protocols, such as JSON and WebSocket connections, is loaded on the display device 200 which displays the code 225 on the display device 200 screen in matrix barcode format. Similar to the herein disclosed embodiments, an app 106 is loaded onto the control device 100. Scanning the matrix barcode code 225 by the control device 100 enables connection and control of the display device 200 via the method 175/185. In an alternate embodiment the code 225 may be visible on a code display device.

In an embodiment, the new and inventive method disclosed herein can be used for the user to connect to and control the display device 200 on the shopping cart, and scanning the UPC code 227 on the product 410 can enable display of additional product information from the database 335. For a food product this information may include nutritional information, recipes, or select marketing of additional products that could be purchased in addition to the product 410. As another exemplary embodiment of a fashion product, such as a designer shoe, the additional information may include fashion or style advice, suggestions on other accessories to mix and match, or video celebrity testimonials, as non-limiting examples. Furthermore, by networking the system 500 to the Enterprise Data Warehouse (EDW) and Point of Sale (POS) of the retail store, one can automate the checkout process, enabling “one click” checkout.

Typical retail systems include a centralized EDW to track inventory, purchases and consumer interactions. The EDW is networked to POS terminals at the checkout in the stores, and is typically part of an enterprise resource planning (ERP) system. National retail chains in the United States may consist of 1000 or more stores, each with approximately 25 POS systems, or more. At the most advanced retailers, data transfer from the POS to the EDW occurs in real time, as the transactions occur or approximately every few minutes.

EDW manufacturers include Oracle, IBM and Teradata, and ERP vendors include Oracle and SAP, where these systems support all common integration methods. POS systems manufacturers include NCR, Epicor Software Corporation and AcuPOS. As an illustrative example, NCR Counterpoint is one such POS system and consists of a POS, inventory management, customer loyalty, automatic purchasing and reporting.

In a preferred embodiment the retail enterprise system consists of a SAP ERP, Teradata EDW, and NCR Counterpoint POS systems, each integrated and networked. Each product is captured by the system 500 in FIG. 9 by scanning the UPC code, preferably using a custom app 106 on the control device 100. These data are stored in the user database 325 using the method disclosed herein, wherein preferably the user database 325 is a table in the EDW, which is already integrated with the corporate ERP and POS systems, using standard methods, languages and protocols, such as JSON and Java. Hence those skilled in the art can extend the system 500 to interface with the EDW/ERP and POS in order to process retail transactions captured by the app 106 and system 500.

Preferably, the display device 200 has an additional integrated payment system, such as a credit card reader, manufactured by Square Inc., or Google Wallet or Apple Payment reader. In this embodiment, users can press the checkout button on the display device 200 and make the payment. In an alternate embodiment, the user 010 takes the cart to the checkout counter and makes the payment. In an embodiment, the user 010 enters a unique identifier, such as a phone number, to retrieve the details of the items in the cart from the database 325 of the system 500. Or preferably, the display device 200 can display a unique identifier specific to the users shopping basket order, preferably in matrix barcode format. The checkout person can scan this code via the POS scanner and the POS can access the order in the inventive system 500 user database 325. In this embodiment the order is processed via the ERP/EDW/POS system, wherein the method saves the step of manually scanning the products.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A system for connecting a control device to a display device, comprising:
(a) a display device;
(b) a server; and
(c) a first control device;
wherein the server is configured to generate a code and transmit the code to the display device;
wherein the display device is configured to display the code as a matrix barcode;
wherein the first control device is configured to scan and decode the matrix barcode;
wherein the first control device is configured to transmit the code decoded by the first control device to the server; and
wherein the server is configured to establish a connection between the first control device and the display device, if the code received from the first control device corresponds to the generated code.

2. The system of claim 1, wherein the connections with the display device and the first control device follow a full-duplex Internet communication protocol.

3. The system of claim 1, wherein the connection between the server and the first control device allows the first control device to control operation of a computer system.

4. The method of claim 1, further comprising:
(d) a second control device configured to scan and decode the matrix barcode;
wherein the second control device is configured to transmit the code decoded by the second control device to the server; and
wherein the server is configured to establish a connection between the second control device and the display device, if the code received from the second control device corresponds to the generated code.

5. The system of claim 4, wherein the connections with the display device and the second control device follow a full-duplex Internet communication protocol.

6. The system of claim 4, wherein the connection with the first control device and the second control device allows the first control device and the second control device to control operation of a computer system.

7. The system of claim 4, further comprising:
(e) an nth control device configured to scan and decode the matrix barcode;
wherein the nth control device is configured to transmit the code decoded by the nth control device to the server; and
wherein the server is configured to establish a connection between the nth control device and the display device, if the code received from the nth control device corresponds to the generated code;
wherein n is an integer, n>2.

8. The system of claim 7, wherein the connections with the display device and the nth control device follow a full-duplex Internet communication protocol.

9. The system of claim 7, wherein the connection with the nth control device allows the nth control device, the first control device and the second control device to collectively control operation of a computer system.

10. A method for connecting a control device to a display device, comprising:
(a) receiving a connection request from the display device;
(b) establishing a connection with the display device, responsive to the connection request;
(c) sending a generated code to the display device;
(d) receiving a code from the control device; and
(e) establishing a connection with the control device, if the received code corresponds to the generated code.

11. The method of claim 10, wherein the received code corresponds to the generated code only if the received code is the same as the generated code.

12. The method of claim 10, wherein connecting the control device is performed using a server.

13. The method of claim 10, wherein the connections with the display device and the control device follow a full-duplex Internet communication protocol.

14. The method of claim 10, wherein the connection with the control device allows the control device to control operation of a computer system.

15. The method of claim 14 wherein the operation of the computer system includes operation of a web page

16. The method of claim 14, wherein the operation of the computer system includes operation of a game.

17. The method of claim 14 wherein the operation of the computer system includes operation of a software application.

18. The method of claim 17, wherein the software application is an ecommerce application.

19. The method of claim 18, wherein the ecommerce application allows for scanning at least one Universal Product Code (UPC) code using the control device.

20. The method of claim 19, wherein the ecommerce application provides information based in part on the UPC.

21. The method of claim 10, wherein sending a generated code to the display device includes displaying the generated code on the display device as a matrix barcode.

22. The method of claim 21, wherein receiving the code from the control device includes scanning the matrix barcode from the display device.

23. The method of claim 10, where the control device is a smartphone.

24. The method of claim 10, further comprising:
(f) receiving a code from a second control device; and
(g) establishing a connection with the second control device, if the received code from the second control device corresponds to the generated code.

25. The method of claim 24, further comprising:
(h) receiving a code from an nth control device; and
(i) establishing a connection with the nth control device, if the received code from the nth control device corresponds to the generated code;
wherein n is an integer, n>2.

26. A method for connecting a control device to a display device, comprising:
(a) using the control device to decode a matrix barcode;
(b) sending a code corresponding to the decoded matrix barcode to a server;
(c) establishing a connection with the server, if the sent code corresponds to a code generated by the server.

27. The method of claim 26, wherein the matrix barcode is displayed on a display device.

28. The method of claim 26, wherein the matrix barcode is displayed on a code display device.

29. The method of claim 26, wherein the matrix barcode is displayed on a printed medium.

30. The method claim 26, wherein the matrix barcode is displayed on a television screen.

31. The method claim 26, wherein the display device is situated at a stadium.

32. The method of claim 26, further comprising: using the control device to decode a universal product code (UPC).

33. A method for connecting a plurality of display devices to a server, comprising:
(a) receiving connection requests from a plurality of display devices;
(b) establishing connections with the display devices, responsive to the connection requests; and
(c) sending a generated code to each of the display devices.

34. The method of claim 33, wherein the connections with the display devices and the server follow a full-duplex Internet communication protocol.

35. The method of claim 33, further comprising:
(d) displaying the code as a matrix barcode on each of the display devices.

36. The method of claim 33, wherein at least one code corresponding to a display device is displayed on a code display device.

37. The method of claim 36, wherein the code displayed on the code display device is determined at least in part on the geographic location of the code display device.

38. The method of claim 33, wherein at least one of the generated codes is based at least in part upon the geographic location of the display device.

39. The method of claim 33, wherein the generated codes are stored in a database.

40. The method of claim 33, wherein a unique code is generated for each of the display devices.

41. The method of claim 33, wherein the code sent to a respective display device is one of a group of codes generated at the server for a cluster of display devices.

42. The method of claim 41, wherein a cluster of display devices is defined in part based upon geographic location.

43. The method of claim 41, wherein the code is stored in a database.

44. The method of claim 33, further comprising:
(d) for each of a plurality of control devices,
scanning a code;
sending the code to the server; and
establishing a connection between the control device and the display device, if the sent code corresponds to a code generated at the server for the display device.

45. The method of claim 44, wherein the connections with the control devices and the server follow a full-duplex Internet communication protocol.

46. The method of claim 44, wherein the server includes a gaming logic engine.

47. The method of claim 44, wherein the server enables ecommerce.

48. The method of claim 44, wherein each of the connections allows one of the control devices to control operation at least of one of the display devices.

49. The method of claim 48, wherein the operation includes operation of a web page.

50. The method of claim 48, wherein the operation includes operation of an interactive game.

51. The method of claim 48, wherein the operation includes execution of a software application.

52. The method of claim 48, wherein the operation includes display of product information.

53. The method of claim 52, wherein the step of (d) further includes scanning a Universal Product Code (UPC) and the display of the product information is based at least in part on the scanned UPC.

54. The method of claim 48, wherein the operation includes operation of an ecommerce application.

55. The method of claim 50, wherein the operation of the interactive game is at least in part enabled by motion sensor input from the control device.

56. The method of claim 50, wherein the interactive game is based on a game selected from the group consisting of basketball, American football, baseball, tennis, golf, hockey, soccer, fishing and bean-bag toss.

57. The method of claim 50, wherein each of the connections allows one of the control devices to control operation of at least one of the display devices that is enabled at least in part by a downloadable gaming logic engine.

58. The method of claim 33, further comprising a method of connecting a plurality of control devices to a cluster of display devices:
(e) for each of the control devices,
scanning the code of one of the display devices;
sending the code to the server; and
establishing a connection between the control device and the group of display devices in the cluster, if the sent code corresponds to one code in a group of codes generated at the server for the cluster of display devices.

59. The method of claim 58, wherein the connection with the control device and the server follow a full-duplex Internet communication protocol.

60. The method of claim 58, wherein the connection allows the control device to simultaneously control operation of multiple display devices in the cluster.

61. The method of claim 44, wherein at least one of the control devices is a smartphone.

62. The method of claim 44, wherein at least one of the control devices is wearable computing eyewear.

63. The method of claim 44, wherein at least one of the control devices is a smart watch.

64. A method for connecting a control device to a display device, comprising:
(a) establishing a connection between a first display software of a display device and a server;
(b) requesting, by the first display software, a first code from the server and displaying the first code on the first display software as a first matrix barcode;
(c) using a first control device, decoding the first matrix barcode;
(d) sending a code corresponding to the decoded first matrix barcode to the server; and
(e) establishing a connection allowing the first control device to control the first display software, if the code sent in (d) corresponds to the first code from the server.

65. The method of claim 64, wherein the connections follow a full-duplex Internet communication protocol.

66. The method of claim 64, wherein the first display software enables a first web page.

67. The method of claim 64, wherein the control includes operation of an interactive game.

68. The method of claim 64, wherein the control includes display of product information.

69. The method of claim 64, wherein the control includes an ecommerce application.

70. The method of claim 64, wherein the first control device is one of a smartphone, wearable computing eyewear, and a smart watch.

71. The method of claim 64, further comprising:
(f) establishing a connection between a second display software of the display device and the server;
(g) requesting, by the second display software, a second code from the server and displaying the second code on the second display software as a second matrix barcode;
(h) using a second control device, decoding the second matrix barcode;
(i) sending a code corresponding to the decoded second matrix barcode to the server; and
(j) establishing a connection allowing the second control device to control the second display software, if the code sent in (i) corresponds to the second code generated by the server.

72. The method of claim 71, wherein the connections follow a full-duplex Internet communication protocol.

73. The method of claim 71, wherein the second display software enables a second web page.

74. The method of claim 71 wherein the first display software and the second display software are the same software application.

75. The method of claim 71, wherein the control includes operation of an interactive game.

76. The method of claim 71, wherein the control includes display of product information.

77. The method of claim 71, wherein the control includes an ecommerce application.

78. The method of claim 71, wherein at least one of the control devices is a smartphone.

79. The method of claim 71, wherein at least one of the control devices is wearable computing eyewear.

80. The method of claim 71, wherein at least one of the control devices is a smart watch.
